(19) United States
(12) Patent Application Publication
(10) Pub. No.: US 2016/0053829 A1
(43) Pub. Date: Feb. 25, 2016

(54) Electromagnetic Clutch

(71) Applicant: SANDEN HOLDINGS CORPORATION, Isesaki-shi, Gunma (JP)

(72) Inventor: Masanori MOGI, Isesaki-shi, Gunma (JP)

(21) Appl. No.: 14/780,923

(22) PCT Filed: Mar. 26, 2014
(86) PCT No.: PCT/JP2014/058450

§ 371 Date: Sep. 28, 2015

(30) Foreign Application Priority Data
Mar. 29, 2013 (JP) 2013-074753

(51) Int. Cl. F16D 27/108; F16D 27/14

(52) U.S. Cl. CPC F16D 27/108; F16D 27/14

(57) ABSTRACT

An electromagnetic clutch easily performs connection of an electromagnetic coil and a power source without impairing its magnetic property. An electromagnetic coil unit 4 causing a rotor and an armature to magnetically engage to enable the transmission of power from a driving source to a compressor, includes: bobbin 42 around which electromagnetic coil 41 is wound; power supply connector 43 attached to connector mounting portion 424 formed in bobbin 42, to connect an external power source to electromagnetic coil 41; and field core 44 accommodating power supply connector 43 and bobbin 42 in an accommodating portion in a state in which power supply connector 43 having fitting portion 43a in which a power connector is fitted is exposed to outside from through hole 443a. Fitting portion 43a of power supply connector 43 faces outward in a radial direction of field core 44.

### TECHNICAL FIELD

The present invention relates to an electromagnetic clutch, and particularly relates to an electromagnetic clutch suitable for intermittently transmitting power of an engine or motor of a vehicle to a vehicle-mounted device (such as a compressor in an air conditioner of the vehicle).

### BACKGROUND ART

As this type of electromagnetic clutch, an electromagnetic clutch disclosed in Patent Document 1 is known as an example. The electromagnetic clutch disclosed in Patent Document 1 has an electromagnetic coil portion including: a bobbin; an electromagnetic coil wound around the bobbin; and a connecting terminal portion for connecting an end of the electromagnetic coil and a power lead wire. The electromagnetic coil portion is accommodated in and fixed to an outer package that also serves as a yoke. In order to connect the connecting terminal portion of the electromagnetic coil portion and the external power lead wire, a notch as a terminal lead-out hole is formed in the outer package, and the connecting terminal portion of the electromagnetic coil portion protrudes outside the outer package from one collar portion of the bobbin through the notch, outward in the bobbin radial direction.

### REFERENCE DOCUMENT LIST

### Patent Document

Patent Document 1: Japanese Patent Application Laid-open Publication No. 2006-349119

### SUMMARY OF THE INVENTION

### Problems to be Solved by the Invention

However, the electromagnetic clutch disclosed in Patent Document 1 has a problem in that the notch in the outer package which also serves as the yoke causes a decrease in magnetic property of the electromagnetic clutch. The electromagnetic clutch also has a problem of poor efficiency in the operation of connecting the electromagnetic coil and the power lead wire because the operation of winding the end of the electromagnetic coil is necessary to connect the electromagnetic coil to the connecting terminal portion and then the operation of attaching a cap member made of an insulating material to the connecting terminal portion is necessary to prevent a short circuit between terminals and a disconnection of the lead wire.

The present invention has been made in view of the above problems, and it has as an object to provide an electromagnetic clutch by which the operation of connecting an electromagnetic coil and a power source is easily performed without impairing its magnetic property.

### Means for Solving the Problems

An electromagnetic clutch according to the present invention is an electromagnetic clutch for intermittently transmitting power of a driving source to a driven device, the electromagnetic clutch including: a rotor rotated by the power of the driving source; an armature facing the rotor, and connected to a rotary shaft of the driven device; and an electromagnetic coil unit having an electromagnetic coil, and for causing, when power is supplied to the electromagnetic coil, the rotor and the armature to magnetically adhere to each other to enable the transmission of the power from the driving source to the driven device. The electromagnetic coil unit includes: a bobbin having a connector mounting portion, around which the electromagnetic coil is wound; a power supply connector attached to the connector mounting portion, and having a fitting portion for a power connector connected to an external power source, the power connector being fitted into the fitting portion to supply the power to the electromagnetic coil; and a field core having a accommodating portion in which a through hole is formed, and for accommodating a proximal side of the power supply connector and the bobbin in the storage portion in a state in which the fitting portion formed on a distal side of the power supply connector is exposed to the outside from the through hole, and the fitting portion of the power supply connector faces outward in a radial direction of the field core.

### Effects of the Invention

In the electromagnetic clutch according to the present invention, the power supply connector is attached to the bobbin around which the electromagnetic coil is wound, and the bobbin is accommodated in the accommodating portion in the field core so that the power connector fitting portion on the distal side of the power supply connector is exposed to the outside from the through hole. Thus, there is no need to form a notch in the field core, and a decrease in magnetic property of the electromagnetic clutch is prevented. Moreover, the power connector fitting portion on the distal side of the power supply connector faces outward in the radial direction of the field core. Therefore, when attaching the electromagnetic clutch to the driven device, the operation of fitting the power connector into the power supply connector is easily performed, and the operation of connecting the electromagnetic coil and the power source is easily performed. Furthermore, the dimension of the power supply connector in the axial direction of the field core is reduced, and thus, it is possible to prevent any interference between the power supply connector and the driven device when attaching the electromagnetic clutch to the driven device. Therefore, the number of driven devices to which the electromagnetic clutch can be attached is increased, and it is possible to lower the costs of electromagnetic clutch-equipped products by component sharing.

### BRIEF DESCRIPTION OF THE DRAWINGS

FIG. 1 is an exploded perspective view of an electromagnetic clutch according to an embodiment of the present invention.

FIG. 2 is a sectional view of the electromagnetic clutch.

FIG. 3 is an exploded perspective view of an electromagnetic coil unit.

FIG. 4 is an enlarged view of a connector mounting portion.

FIG. 5 is an enlarged sectional view of a power supply connector.

FIG. 6 is an enlarged perspective view of a connecting terminal of the power supply connector.

FIG. 7 is an assembly view of the electromagnetic coil unit.

### MODE FOR CARRYING OUT THE INVENTION

Hereinafter, embodiments of the present invention will be described with reference to the accompanying drawings.

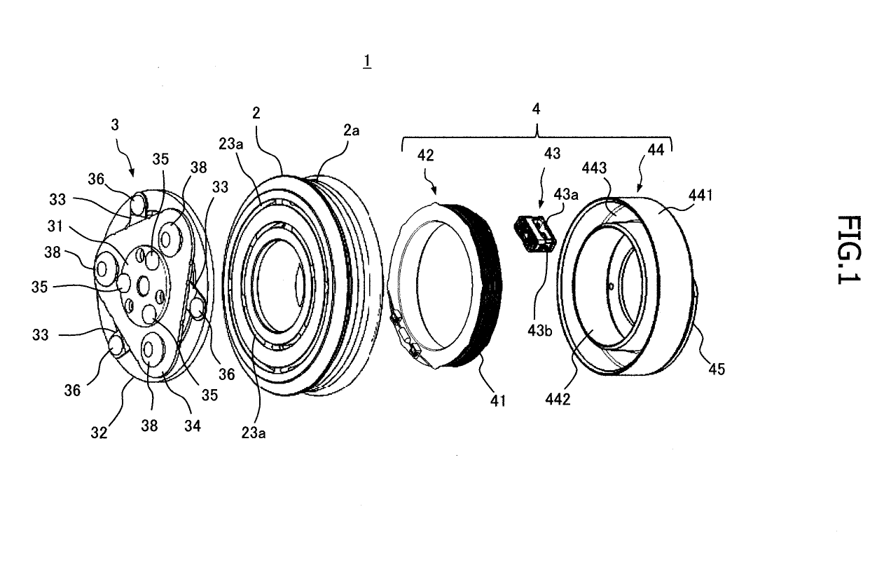

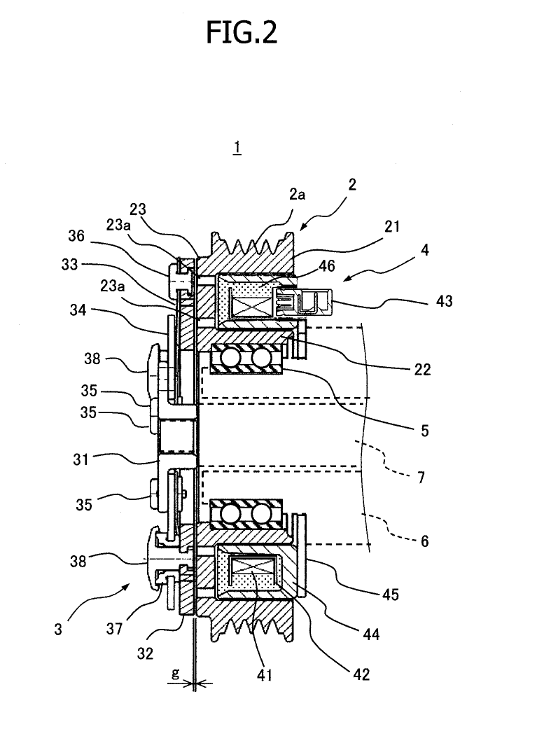

FIGS. 1 and 2 illustrate the structure of an electromagnetic clutch 1 according to an embodiment of the present invention. FIG. 1 is an exploded perspective view of the electromagnetic clutch 1, and FIG. 2 is a sectional view of the electromagnetic clutch 1.

For example, the electromagnetic clutch 1 according to this embodiment is incorporated in a compressor in an air conditioner of a vehicle, and intermittently transmits power of an engine or motor of the vehicle as a driving source to the compressor as a driven device. In detail, the electromagnetic clutch 1 switches between transmitting and interrupting power from the engine or the motor to the compressor. The compressor operates when power is transmitted from the engine or the motor, and stops operation when power from the engine or the motor is interrupted.

As illustrated in FIGS. 1 and 2, the electromagnetic clutch 1 includes: a rotor 2 rotated by the power of the engine or motor; an armature 3 facing the rotor 2; and an electromagnetic coil unit 4 for causing the rotor 2 and the armature 3 to magnetically adhere to each other.

The rotor 2 is ring-shaped, and its inner peripheral surface is rotatably supported by the outer peripheral surface of a housing 6 (indicated by dashed lines in FIG. 2) of the compressor via a bearing 5. A belt groove 2a is formed in the outer peripheral surface of the rotor 2, and the outer peripheral surface of the rotor 2 functions as a pulley. In more detail, the rotor 2 includes: an outer cylindrical portion 21 having the outer peripheral surface; an inner cylindrical portion 22 having the inner peripheral surface and concentric with the outer cylindrical portion 21; and an annular disk-shaped connecting portion 23 connecting the outer cylindrical portion 21 and the inner cylindrical portion 22 at one end. These are integrated to form the rotor 2 (see FIG. 2). The connecting portion 23 serving as one end surface of the rotor 2 has slits 23a intermittently extending in the circumferential direction, as a magnetic flux blocking portion.

A driving belt (not illustrated) is attached to the outer peripheral surface of the rotor 2 in which the belt groove 2a is formed. The rotor 2 is rotated by the power of the engine or motor transmitted via the driving belt. The electromagnetic coil unit 4, described later, is placed in the space defined by the outer cylindrical portion 21, the inner cylindrical portion 22, and the connecting portion 23.

The armature 3 includes: a cylindrical hub 31 having a flange portion; a disk-shaped armature plate 32 made of a magnetic material; a plurality of (three in this example) leaf springs 33; and a triangular damping plate 34.

The hub 31 is fixed (connected) to one end of a rotary shaft (driving shaft) 7 (indicated by dashed lines in FIG. 2) of the compressor protruding outside the housing 6 by a nut (not illustrated), in a spline-engaged state as an example.

The armature plate 32 faces the end surface (the connecting portion 23) of the rotor 2.

Each of the leaf springs 33 has one end fixed to the flange portion of the hub 31 by a rivet 35 together with the damping plate 34, and the other end fixed to the armature plate 32 by a rivet 36. Each of the leaf springs 33 biases the armature plate 32 away from the end surface (the connecting portion 23) of the rotor 2. This creates a predetermined gap g between the end surface (the connecting portion 23) of the rotor 2 and the armature plate 32.

The damping plate 34 has antivibration rubber 37 attached near each vertex thereof. The damping plate 34 and the antivibration rubber 37 are fixed to the armature plate 32 by a rivet 38, and they damp vibration generated in the armature plate 32.

The electromagnetic coil unit 4 includes: an electromagnetic coil 41; a bobbin 42 around which the electromagnetic coil 41 is wound; a power supply connector 43 attached to the bobbin 42; and a field core 44.

A mounting plate 45 is attached to one end surface of the field core 44. The electromagnetic coil unit 4 is accommodated in the above-mentioned space (that is, the space defined by the outer cylindrical portion 21, the inner cylindrical portion 22, and the connecting portion 23) of the rotor 2, in a state in which the electromagnetic coil unit 4 is mounted on (fixed to) the housing 6 of the compressor via the mounting plate 45 (see FIG. 2).

When a power connector (not illustrated) connected to an external power source is fitted in the power supply connector 43 to supply power to the electromagnetic coil unit 4, the electromagnetic coil 41 is energized to generate an electromagnetic force, to cause the armature plate 32 to magnetically adhere to the end surface (the connecting portion 23) of the rotor 2 against the biasing force of the leaf springs 33. The rotor 2 and the armature 3 are thus connected. The rotary force of the rotor 2 (that is, the power of the engine or motor) is transmitted to the armature 3, and is further transmitted to the rotary shaft 7 of the compressor, as a result of which the compressor operates.

When the power supply to the electromagnetic coil unit 4 is stopped, on the other hand, the armature plate 32 is apart from the end surface (the connecting portion 23) of the rotor 2 by the biasing force of the leaf springs 33. The transmission of the rotary force of the rotor 2 is thus interrupted, as a result of which the compressor stops.

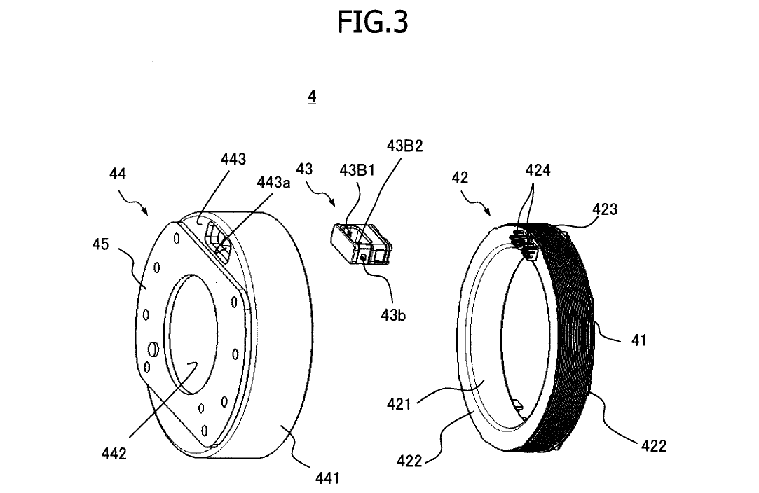

FIG. 3 is an exploded perspective view of the electromagnetic coil unit 4 seen from the opposite side to FIG. 1.

As illustrated in FIG. 3, the bobbin 42 includes: a cylindrical portion 421 around which outer peripheral surface the electromagnetic coil 41 is wound; and flange portions 422 provided on both ends of the cylindrical portion 421. A connector mounting portion 424 to which the power supply connector 43 is attached is provided on the outer surface of one of the flange portions 422. The connector mounting portion 424 may be formed integrally with the bobbin 42 (the flange portion 422), or formed as a separate part and fixed to the bobbin 42 (the flange portion 422).

The connector mounting portion 424 is provided on the outer surface of the flange portion 422 so that the connector mounting portion 424 sandwiches a notch 423. In detail, the connector mounting portion 424 is separated into a right part positioned at the right side of the notch 423 and a left part positioned at the left side of the notch 423, as seen from the outside of the flange portion 422. However, the present invention is not limited to this, as long as the connector mounting portion 424 is near the notch 423.

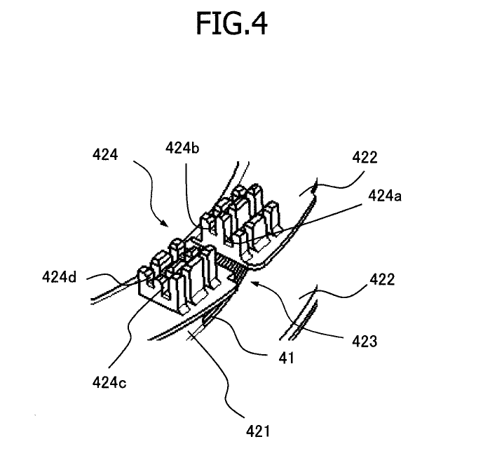

FIG. 4 is an enlarged view of the connector mounting portion 424. As illustrated in FIG. 4, the right part of the connector mounting portion 424 has: a first groove portion 424a extending away from the notch 423 along the outer surface of the flange portion 422; and a second groove portion 424b extending in parallel with the first groove portion 424a. Likewise, the left part of the connector mounting portion 424 has: a third groove portion 424c extending away from the notch 423 along the outer surface of the flange portion 422; and a fourth groove portion 424d extending in parallel with the third groove portion 424c.

One end of the electromagnetic coil 41 wound around the outer peripheral surface of the cylindrical portion 421 is fitted in the first groove portion 424a and the other end of the electromagnetic coil 41 is fitted in the third groove portion 424c. In detail, each end of the electromagnetic coil 41 wound around the outer peripheral surface of the cylindrical portion 421 is drawn out of the flange portion 422 through the notch 423, and is then bent opposite to each other and fitted in the first groove portion 424a and the third groove portion 424c. Meanwhile, a lead wire of a diode (back surge absorber) (not illustrated) is fitted in the second groove portion 424b and and another lead wire of the diode is fitted in the fourth groove portion 424d. Although the connector mounting portion 424 has the second groove portion 424b and the fourth groove portion 424d in which the lead wires of the diode are fitted in this example, the connector mounting portion 424 may have only the first groove portion 424a and the third groove portion 424c into each of which an end of the electromagnetic coil 41 is fitted.

The power supply connector 43 is attached to (pressed against) the connector mounting portion 424 of the bobbin 42, and has a fitting portion 43a, described later, in which the power connector (not illustrated) connected to the external power source, is fitted. By fitting the power connector in the fitting portion 43a, the electromagnetic coil 41 is supplied with power. Locking portions 43b for locking the power connector are formed on both outer peripheral surfaces of the power supply connector 43 in the longitudinal direction of the fitting portion 43a.

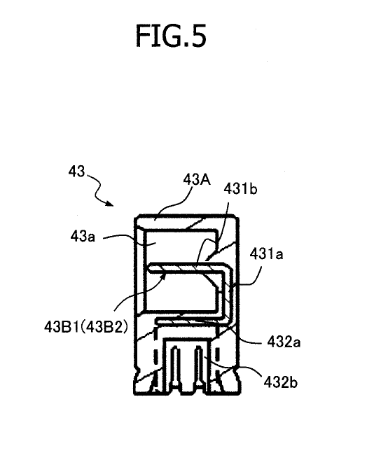

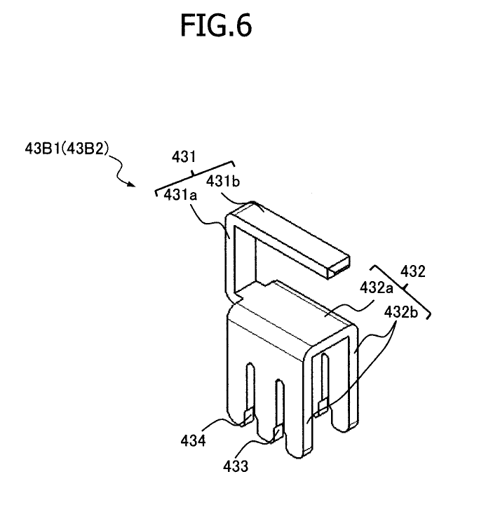

In detail, as illustrated in FIG. 5, the power supply connector 43 is formed by incorporating two connecting terminals 43B1 and 43B2 made of a conductive material into a connector wall 43A made of an insulating material by using an insert-molding process. The shape of each of the connecting terminals 43B1 and 43B2 is illustrated in FIG. 6. The connecting terminals 43B1 and 43B2 have the same shape, and each include: a power connecting terminal portion 431 for connecting to the power source when the power connector (not illustrated) is fitted; and an electromagnetic coil connecting terminal portion 432 for connecting to the electromagnetic coil 41 when the power supply connector 43 is attached to the connector mounting portion 424. The power connecting terminal portion 431 includes: a proximal portion 431 a extending substantially in parallel with the axial direction of the field core 44 in a state in which the power supply connector 43 is attached to the connector mounting portion 424; and a distal portion 431b bent substantially in an L-shape from one end of the proximal portion 431a outward in the radial direction of the field core 44, and the distal portion 431 b protruding in the above-mentioned fitting portion 43a surrounded by the connector wall 43A. The electromagnetic coil connecting terminal portion 432 includes: a proximal portion 432a extending from the other end of the proximal portion 431a of the power connecting terminal portion 431 outward in the radial direction of the field core 44; and distal portions 432b each having an electromagnetic coil sandwiching portion 433 and diode sandwiching portion 434 formed in a slit-shape toward the proximal portion 432a along the axial direction of the field core 44.

The electromagnetic coil connecting terminal portion 432 is substantially U-shaped so that the distal portions 432b face each other with the proximal portion 432a interposed therebetween. Although the electromagnetic coil connecting terminal portion 432 of the connecting terminal 43B is substantially U-shaped with the distal portions 432b facing each other in this embodiment, the distal portions 432b may be a flat-plate shape instead of a U-shape.

In the power supply connector 43 in this embodiment, as illustrated in FIG. 5, the proximal portion 431a of the power connecting terminal portion 431 and the proximal portion 432a of the electromagnetic coil connecting terminal portion 432 are located within the connector wall 43A. In addition, both edges of the distal portions 432b of the electromagnetic coil connecting terminal portion 432 are embedded within the connector wall 43A. This configuration decreases the axial dimension and radial dimension of the field core 44 in the power supply connector 43. The proximal portion 431a of the power connecting terminal portion 431, the proximal portion 432a of the electromagnetic coil connecting terminal portion 432, and both edges of the distal portions 432b of the electromagnetic coil connecting terminal portion 432 are located within the connector wall 43A in the power supply connector 43 in this embodiment; however, if at least one of: the proximal portion 431a of the power connecting terminal portion 431; the proximal portion 432a of the electromagnetic coil connecting terminal portion 432; and both edges of the distal portions 432b of the electromagnetic coil connecting terminal portion 432 is located within the connector wall 43A, the power supply connector 43 can be miniaturized.

The field core 44 is ring-shaped similar to the rotor 2, as illustrated in FIGS. 1 to 3. In detail, the field core 44 includes: an outer cylindrical portion 441; an inner cylindrical portion 442 concentric with the outer cylindrical portion 441; and an annular disk-shaped connecting portion 443 connecting the outer cylindrical portion 441 and the inner cylindrical portion 442 at one end. The connecting portion 443 has a through hole 443a. The through hole 443a has a size which corresponds to the size of the power supply connector. The mounting plate 45 is attached to the outer surface of the connecting portion 443.

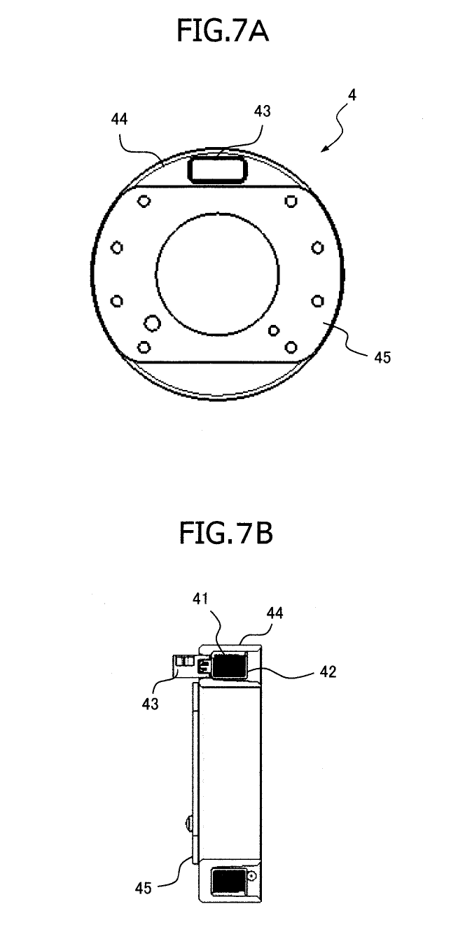

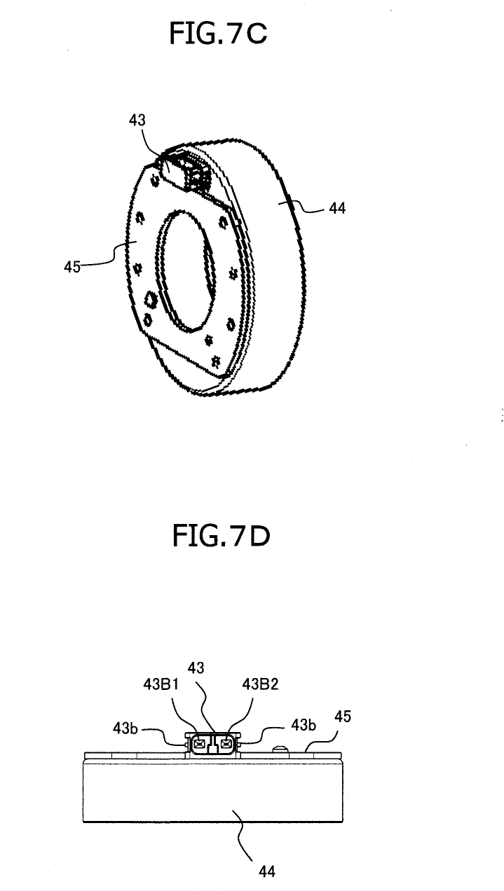

The field core 44 accommodates the bobbin 42 to which the power supply connector 43 is attached, in the space defined by the outer cylindrical portion 441, the inner cylindrical portion 442, and the connecting portion 443. In more detail, as illustrated in FIGS. 7A to 7D, the field core 44 accommodates the proximal side of the power supply connector 43 and the bobbin 42 in the above-mentioned space in a state in which the distal side of the power supply connector 43 is exposed to the outside from the through hole 443a. The space is then filled with resin to thereby seal the electromagnetic coil 41, and the electromagnetic coil 41, the bobbin 42, the power supply connector 43, and the field core 44 are integrated to form the electromagnetic coil unit 4.

The space defined by the outer cylindrical portion 441, the inner cylindrical portion 442, and the connecting portion 443 corresponds to “an accommodating portion in which a through hole is formed” of the present invention.

The following briefly describes an example of the assembly procedure of the electromagnetic coil unit 4.

First, in a state in which one end of the electromagnetic coil 41 is drawn to outside the flange portion 422 of the bobbin 42 through the notch 423 formed in the flange portion 422, the electromagnetic coil 41 is wound around the outer peripheral surface of the cylindrical portion 421 of the bobbin 42, and the other end of the electromagnetic coil 41 that has been wound is drawn to outside the flange portion 422 of the bobbin 42 through the notch 423 formed in the flange portion 422.

Following this, one end of the electromagnetic coil 41 is fitted into the first groove portion 424a formed in the right part of the connector mounting portion 424, and the other end of the electromagnetic coil 41 is fitted into the third groove portion 424c formed in the left part of the connector mounting portion 424. Here, both ends of the electromagnetic coil 41 are bent opposite to each other.

Following this, one lead wire of the diode is fitted into the second groove portion 424b formed in the right part of the connector mounting portion 424, and the other lead wire of the diode is fitted into the fourth groove portion 424d formed in the left part of the connector mounting portion 424.

Following this, the power supply connector 43 is attached to the connector mounting portion 424 so that the slit-shaped electromagnetic coil sandwiching portion 433 and diode sandwiching portion 434 formed in each distal portion 432b of the electromagnetic coil connecting terminal portion 432 of the power supply connector 43, are pressed against both ends of the electromagnetic coil 41 and both lead wires of the diode fitted in the groove portions 424a to 424d of the connector mounting portion 424, to thereby integrate the bobbin 42 and the power supply connector 43. As a result, one connecting terminal 43B1 of the power supply connector 43 is electrically connected to one end of the electromagnetic coil 41 and one lead wire of the diode, and the other connecting terminal 43B2 of the power supply connector 43 is electrically connected to the other end of the electromagnetic coil 41 and the other lead wire of the diode. Here, the power supply connector 43 is attached to the connector mounting portion 424 so that the fitting portion 43a of the power supply connector 43 faces outward in the radial direction of the bobbin 42.

Following this, the bobbin 42, to which the power supply connector 43 is attached, is accommodated into the space (accommodating portion) defined by the outer cylindrical portion 441, inner cylindrical portion 442, and connecting portion 443 of the field core 44. Here, the fitting portion 43a on the distal side of the power supply connector 43 is exposed outside the field core 44 from the through hole 443a formed in the connecting portion 443 of the field core 44. In other words, the power supply connector 43 protrudes from the through hole 443a substantially in parallel with the axial direction of the field core 44, and the fitting portion 43a of the power supply connector 43 is exposed outside the field core 44 in a state of facing outward in the radial direction of the field core 44. Since there is no notch in the outer periphery of the field core 44, the magnetic property of the electromagnetic clutch 1 is not impaired. Moreover, since the power supply connector 43 does not protrude outward in the radial direction of the field core 44, the space outward in the radial direction of the field core 44 can be effectively used and the installation space of the electromagnetic clutch 1 can be reduced.

Following this, the space (accommodating portion) defined by the outer cylindrical portion 441, inner cylindrical portion 442, and connecting portion 443 of the field core 44 is filled with resin to seal the electromagnetic coil 41, and the proximal side of the power supply connector 43 and the bobbin 42 are fixed to the field core 44, so that insulation is ensured. Furthermore, the resin also seals the space between the connector mounting portion 424 of the bobbin 42 and the power supply connector 43, so that the waterproof performance of the electrically connected parts is ensured.

The mounting plate 45 is then attached to the outer surface of the connecting portion 443 of the field core 44, thus completing the assembly of the electromagnetic coil unit 4. The electromagnetic coil unit 4 is accommodated in the rotor 2 in a state of being fixed to the housing 6 of the compressor via the mounting plate 45, as mentioned above.

In the electromagnetic clutch 1 described above, the power supply connector 43 protrudes outside the field core 44 from the through hole 443a formed in the connecting portion 443 of the field core 44. Thus, there is no need to form a notch in the field core 44, and the magnetic property of the electromagnetic clutch 1 is not impaired. Moreover, in the power supply connector 43, the fitting portion 43a in which the power connector is fitted faces outward in the radial direction of the field core 44. Accordingly, the power connector can be easily fitted into the power supply connector 43 from outside in the radial direction of the field core 44, and thus, the operation of connecting the electromagnetic coil 41 and the external power source is easy. Furthermore, merely fitting the power supply connector 43 into the connector mounting portion 424 enables the electromagnetic coil 41 to be electrically connected to the connecting terminals 43B1 and 43B2. Therefore, the conventional operation of winding the electromagnetic coil around the connecting terminal portion and operation of attaching a cap member to the connecting terminal portion are unnecessary.

In addition, the connecting terminals 43B1 and 43B2 of the power supply connector 43 are substantially U-shaped, and the proximal portion 431 a of the power connecting terminal portion 431 and the proximal portion 432a of the electromagnetic coil connecting terminal portion 432 are embedded within the connector wall 43A, so that the axial dimension and radial dimension of the field core 44 in the power supply connector 43 are reduced. Accordingly, the dimension of the power supply connector 43 exposed from the field core 44 is shortened, and it is possible to avoid a problem in which the power supply connector 43 interferes with the compressor, so that the operation of attaching the electromagnetic clutch 1 is not performed. Therefore, the number of various compressors to which the electromagnetic clutch can be attached is increased, and it is possible to lower costs of electromagnetic clutch-equipped products by component sharing.

Furthermore, the electromagnetic coil 41 and the external power source can be connected easily, and insulation performance, waterproof performance, and the like are ensured by filling the accommodating portion with resin. Therefore, the electromagnetic clutch 1 can be manufactured easily and the number of manufacturing steps and the manufacturing cost can be reduced significantly, as compared with conventional techniques. Furthermore, the length of the power supply connector 43 protruding outside from the through hole 443a of the field core 44 is short, which enables effective use of the space outward in the axial direction of the field core 44 and reduces the installation space of the electromagnetic clutch 1.

Hereinabove, although a preferred embodiment of the present invention has been described, the present invention is not limited to the foregoing embodiment, and it can be variously modified and changed based on the technical idea of the present invention.

### REFERENCE SYMBOL LIST

1 Electromagnetic clutch
2 Pulley
3 Armature
4 Electromagnetic coil unit
5 Bearing
6 Housing of compressor
7 Rotary shaft of compressor
41 Electromagnetic coil
42 Bobbin
43 Power supply connector
43A Connector wall
43B1, 43B2 Connecting terminal
43a Fitting portion
44 Field core
45 Mounting plate
424 Connector mounting portion
431 Power connecting terminal portion
431a Proximal portion of power connecting terminal portion
431b Distal portion of power connecting terminal portion
432 Electromagnetic coil connecting terminal portion
432a Proximal portion of electromagnetic coil connecting terminal portion
432b Distal portion of electromagnetic coil connecting terminal portion
443a Through hole

1. An electromagnetic clutch for intermittently transmitting power of a driving source to a driven device, the electromagnetic clutch comprising:
a rotor rotated by the power of the driving source;
an armature facing the rotor, and connected to a rotary shaft of the driven device; and
an electromagnetic coil unit having an electromagnetic coil, and for causing, when power is supplied to the electromagnetic coil, the rotor and the armature to magnetically adhere to each other to enable the transmission of the power from the driving source to the driven device,
wherein the electromagnetic coil unit includes:
a bobbin having a connector mounting portion, and around which the electromagnetic coil is wound;
a power supply connector attached to the connector mounting portion, and having a fitting portion for a power connector connected to an external power source, the power connector being fitted into the fitting portion to supply the power to the electromagnetic coil; and
a field core having an accommodating portion in which a through hole is formed, and accommodating a proximal side of the power supply connector and the bobbin in the accommodating portion in a state in which the fitting portion formed on a distal side of the power supply connector is exposed to the outside from the through hole, and
wherein the fitting portion of the power supply connector faces outward in a radial direction of the field core.

2. The electromagnetic clutch according to claim 1, wherein the power supply connector includes: a pair of power connecting terminal portions for connecting to the power source when the power connector is fitted in the fitting portion; and a pair of electromagnetic coil connecting terminal portions for connecting to the electromagnetic coil when the power supply connector is attached to the connector mounting portion,
wherein each of the power connecting terminal portions includes: a proximal portion substantially in parallel with an axial direction of the field core; and a distal portion bent substantially in an L-shape from one end of the proximal portion outward in the radial direction of the field core and protruding in a space of the fitting portion surrounded by a connector wall made of an insulating material, and
wherein each of the electromagnetic coil connecting terminal portions includes: a proximal portion extending from the other end of the proximal portion of the power connecting terminal portion outward in the radial direction of the field core; and one or more distal portions each having a slit-shaped electromagnetic coil sandwiching portion toward the proximal portion of the electromagnetic coil connecting terminal portion along the axial direction of the field core.

3. The electromagnetic clutch according to claim 2, wherein each of the electromagnetic coil connecting terminal portions is substantially U-shaped so that the distal portions face each other with the proximal portion interposed therebetween.

4. The electromagnetic clutch according to claim 2, wherein in the power supply connector, the proximal portion of each of the power connecting terminal portions is located within the connector wall.

5. The electromagnetic clutch according to claim 2, wherein in the power supply connector, the proximal portion of each of the electromagnetic coil connecting terminal portions is located within the connector wall.

6. The electromagnetic clutch according to claim 2, wherein in the power supply connector, both edges of the distal portions of each of the electromagnetic coil connecting terminal portions are located within the connector wall.
